(19) United States
(12) Patent Application Publication
(10) Pub. No.: US 2017/0053192 A1
(43) Pub. Date: Feb. 23, 2017

(54) SYSTEMS AND METHODS FOR DETECTING PARKING OCCUPANCY STATUS

(71) Applicant: Parking Vision Information Technologies, INC., McKinney, TX (US)

(72) Inventors: Jennifer Ding, McKinney, TX (US); CJ Barberan, Houston, TX (US); Xin Huang, Redmond, WA (US); Zihe Huang, Houston, TX (US)

(73) Assignee: Parking Vision Information Technologies, INC., McKinney, TX (US)

(21) Appl. No.: 15/239,075

(22) Filed: Aug. 17, 2016

Related U.S. Application Data
(60) Provisional application No. 62/206,813, filed on Aug. 18, 2015.

(51) Int. Cl. G06K 9/62; G06K 9/00; G06K 9/46; G08G 1/14

(52) U.S. Cl. CPC G06K 9/6269; G08G 1/14; G06K 9/00785; G06K 9/4604

(57) ABSTRACT

A parking occupancy detection system includes a camera and one or more processors communicatively coupled to the camera. The one or more processors are collectively configured to receive an image of a parking region from the camera, wherein the parking region comprises a parking spot, extract an image of the parking spot from the image of the parking region, obtain an image descriptor value of the image of the parking spot, input the image descriptor value into a dynamic classification model, and classify the image descriptor value as occupied or unoccupied based on training data, wherein the training data comprises examples of occupied image descriptor values and unoccupied image descriptor values.

### BACKGROUND

With the increasing number of vehicles on the road and limited real estate, efficient parking management has become ever-important for parking providers, drivers, and city management alike. One challenge drivers face is being unaware of the occupancy of a parking lot or road-side parking upon approach, and may waste time driving around searching for an available parking spot. Having this information will save drivers time and reduce road crowding. For parking providers, it may be challenging to track occupancy and use statistics of their properties over time. Being able to track occupancy can help them more efficiently manage the space and provide a better parking experience to their customers.

Current means of detecting parking occupancy typically require sensors at individual parking spots within a parking lot, which detect whether a vehicle is occupying the spot or not. This requires large amounts of hardware and implementation, which is cost and time consuming to implement.

Other means of detecting parking occupancy that utilize cameras and image processing to monitor the parking lot are not robust enough to accurately determine the occupancy status of each parking spot within the parking lot given the many real-life conditions of the parking spots. Specifically, there may be many conditions in which a parking spot does not appear to be perfectly occupied or perfectly unoccupied. For example, there may be debris in a parking spot or a misparked neighboring vehicle that renders the parking spot unavailable for parking, but goes undetected by existing parking detection means. There may also be weather or lighting conditions, or other visual obstructions that render the systems unable to accurately determine the true occupancy status of the parking spot. Thus, a more robust means of determining parking occupancy would be beneficial, especially for applications that share live occupancy data with drivers.

### SUMMARY

A method of detecting parking occupancy status includes training a dynamic classification model. The training includes obtaining a plurality of parking spot training images, wherein each of the parking spot training images is associated with a known occupancy status. Then a training image descriptor value is obtained from each of the parking spot training images, wherein each training image descriptor value is associated with the respective known occupancy status. The training image descriptor value and its associated known occupancy status is input into a dynamic classification model as training data, and a parking spot occupancy classification rule is generated through the dynamic classification model based on the training data.

A method of detecting parking occupancy includes obtaining an image of a parking region from an on-site camera, wherein the parking region comprises a parking spot. The method further includes extracting an image of the parking spot from the image of the parking region and obtaining an image descriptor value of the image of the parking spot. The method further includes inputting the image descriptor value into a dynamic classification model, and classifying the image descriptor value as occupied or unoccupied based on training data, wherein the training data comprises examples of occupied image descriptor values and unoccupied image descriptor values.

A parking occupancy detection system includes a camera and one or more processors communicatively coupled to the camera. The one or more processors are collectively configured to receive an image of a parking region from the camera, wherein the parking region comprises a parking spot, extract an image of the parking spot from the image of the parking region, obtain an image descriptor value of the image of the parking spot, input the image descriptor value into a dynamic classification model, and classify the image descriptor value as occupied or unoccupied based on training data, wherein the training data comprises examples of occupied image descriptor values and unoccupied image descriptor values.

### BRIEF DESCRIPTION OF THE DRAWINGS

Various other objects, features, and advantages of the present invention will become fully appreciated and better understood when considered in conjunction with the accompanying illustrative and non-limiting drawings, in which like reference characters designate the same or similar parts throughout the several views, and wherein:

FIG. 1 illustrates a parking occupancy detection operation, in accordance with one or more embodiments;

FIG. 2 illustrates a block diagram of a system for detecting parking occupancy, in accordance with one or more embodiments;

FIG. 3 illustrates a method of training a dynamic classification model using generic parking images, in accordance with one or more embodiments;

FIG. 4A illustrates an example histogram of oriented gradients (HOG) image descriptor of a parking spot training image that is associated with an occupied status, in accordance with one or more embodiments;

FIG. 4B illustrates an example HOG image descriptor of a parking spot training image that is associated with an unoccupied status, in accordance with one or more embodiments;

FIG. 5 illustrates a method of training a dynamic classification model using region-specific parking spot training images, in accordance with one or more embodiments; and

FIG. 6 illustrates a method of using a dynamic classification model to determine parking occupancy, in accordance with one or more embodiments.

### DETAILED DESCRIPTION

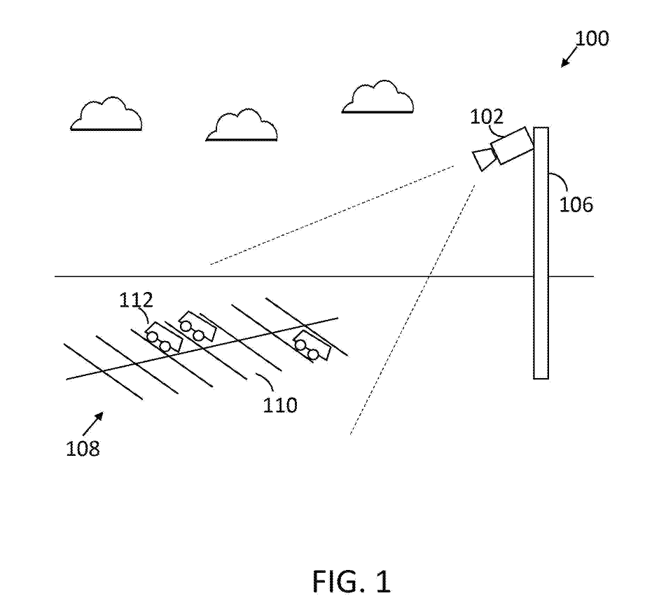

Referring to the drawings, FIG. 1 illustrates a parking occupancy detection operation 100, in accordance with one or more embodiments. A camera 102 is located with a parking region 108 within view. The parking region 108 includes one or more parking spots 110 which may or may not be occupied by a vehicle 112. The camera 102 may be mounted on a nearby structure 106 such as a building, a utility pole, or a structure especially designed to support the camera 102. The camera 102 may be a video camera or a still image camera configured to capture images of the parking region 108. In an embodiment that utilizes a video camera, the video camera may be configured to continuously record the parking region 108 over a certain period of time, for example during the time periods in which the parking region 108 is operational. In certain such embodiments, an image from the continuous recording may be captured at predetermined time intervals or on command. Alternatively, if the camera 102 is a still image camera, the camera may be configured to take a picture of the parking region 108 at predefined time intervals or on command. In a preferred embodiment, the camera 102 is able to capture the entire parking region 108 within its view. Alternatively, more than one camera 102 may be employed to capture the entire parking region 108. The camera 102 may be a pan-tilt-zoom camera which has the ability to move panoramically, tilt to different angles, and zoom to specific views to capture the entire parking region 108. In a preferred embodiment, the camera 102 is positioned such that it has a bird's eye view of the parking region 108.

In one or more embodiments, a parking spot 110 is either considered “occupied” or “unoccupied”. A parking spot 110 may be considered unoccupied if it is available for a vehicle to park therein. A parking spot 110 may be considered occupied if there is already a vehicle 112 parked therein. A parking spot 110 may also be considered occupied if there is any other condition in which a vehicle would not be able to park in that spot 110. For example, there may be obstructions in the parking spot 110 such as large debris, traffic cones, a misparked neighboring vehicle, among others, that would make the parking spot 110 unavailable for parking. Ultimately, the purpose of the system is to determine the parking occupancy status of each parking spot 110 within the parking region 108. The present disclosure is applicable to any kind of vehicle, including cars, motorcycles, bicycles, airplanes, boats, among others, as well as any type of parking region.

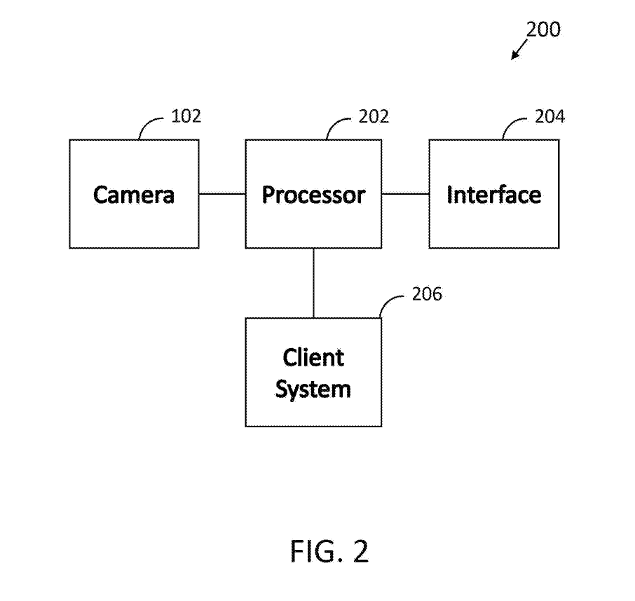

FIG. 2 illustrates a block diagram of a system 200 for detecting parking occupancy, in accordance with one or more embodiments. The illustrated system 200 includes the on-site camera 102, a processor 202, and an interface 204. The system 200 is also communicative with a client system 206. The processor 202 may be located within the camera 102, locally coupled to the camera 102, or remote from the camera 102, such as a part of a cloud server. The processor 202 may be a combination of multiple processors located locally or remotely from each other. Accordingly, functions carried out by the processor 202 can be carried out by one processor or jointly carried out by a plurality of processors. In one or more embodiments, the on-site camera 102 may be internet-connected and transmit image data to the processor 202 via the internet. The on-site camera 102 may be retro-fitted with an internet or wifi-enabled add-on, thereby making an otherwise unconnected camera internet-connected.

The interface 204 is coupled to the processor 202 and may be connected to, local to, or remote from the processor 202. The interface 204 provides a means for interacting with the processor 202. For example, the interface 204 may be used to input various information into the processor 202, such as meta-data regarding the parking region 108, training data (which will be described below), illustrative maps, among others. The interface 204 may also provide a means for the processor 202 to output data, such as determined parking occupancy status. The interface 204 may further process the data received from the processor 202 to present the data in a user friendly format according to a user interface/user experience (UI/UX) design. For example, the interface 204 may include a map of the parking region 108 that shows the occupancy of each parking spot 110 within the parking region 108.

In one example, the on-site camera 102 is internet-connected and directly sends the video feed or image captures to a remote processor 202 such as a cloud server. The remote processor 202 then performs all the image processing and analysis needed to determine parking occupancy. In this embodiment, the interface 204 may be a part of the remote processor 202 or on a computing device remote from the processor 202 and communicatively coupled via the internet. In one such embodiment, the camera 102, the processor 202, and the interface 204 may all be in geographically separate locations. In another embodiment, the interface 204 may be located local to the camera 102. In yet another embodiment, the interface 204 is stored in the processor 202 and served along with the output data to any connected device, for example any one or more computers, mobile device, or other hardware.

In another example, the on-site camera 102 is communicatively coupled to an on-site processor 202, either as a part of the camera 102 itself or a wired or wirelessly connected computer. The on-site processor 202 then performs all or a portion of the image processing and analysis needed to determine parking occupancy. In certain such embodiments, the interface 204 is located on the processor 202 or a local device. Thus, the on-site processor can then access the camera on-site and the camera images or data may not need to be sent elsewhere via the internet. This results in increased data security and lower data transmission resources or fees.

In one or more embodiments, the system 200 is configured to keep updating the occupancy status of the parking spots 110 in real time, quasi-real time, at predetermined time intervals, or upon receiving an update command. The occupancy status may be stored in a memory device coupled the processor 202 or sent to a separate processor. A historical record on the occupancy status over time may be stored as well. The occupancy status may be served to one or more client systems 206 or made accessible to one or more clients systems 206 in real time, quasi-real time, at predetermined intervals, or upon command. For example, the parking occupancy data can be accessed by drivers and parking operators through a web or mobile interface on a remote device to inform real-time parking decisions. The parking occupancy data can be accessed by a third-party who may then serve the data to drivers or operators through a third-party API or user interface. In one or more embodiments, occupancy data collected over time is also used to generate analytics reports to help parking operators improve their operations, pricing policies, and make future planning decisions.

The present disclosure provides systems and methods for determining the occupancy status of the parking spots 110 based on the images captured by the camera 102. Specifically, the methods utilize machine learning techniques to classify each parking spot 110 as occupied or unoccupied. In one or more embodiments, the method includes first training a dynamic classification model to be able to produce high accuracy classification decisions. The method then uses the trained dynamic classification model to classify a parking spot 110 as occupied or unoccupied based on an image of the parking spot 110.

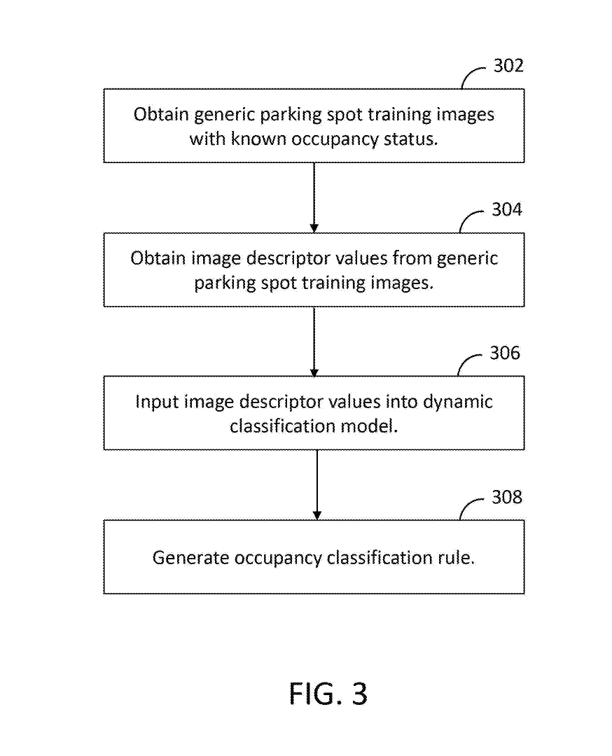

FIG. 3 illustrates a method of training a dynamic classification model using generic parking images, in accordance with one or more embodiments. The method includes obtaining a plurality of generic parking spot training images, each of which has a known occupancy status (step 302). The generic parking spot training images include images of occupied parking spots as well as images of unoccupied parking spots. The generic parking spot training images may be of any parking spot, and do not have to be images of parking spots of the specific parking region 110 to which the dynamic classification model will be applied.

A respective image descriptor value is then extracted from each of the generic parking spot training images (step 304). An image descriptor is a numerical or data representation of a visual feature of an image, such as histogram of oriented gradients, pixel intensity, pixel red-green-blue values, pixel hue-saturation-value values, a general histogram, among others. An image descriptor is a much smaller piece of data than the image file itself, and yet includes highly useful information for machine-analysis of the visual content of the image, such as in determining whether the parking spot in the image is occupied or unoccupied. Thus, analyzing an image descriptor of an image instead of the image file itself requires less computing and communication resources. Each of the image descriptor values is also associated with the respective known occupancy status and are collectively known as training data.

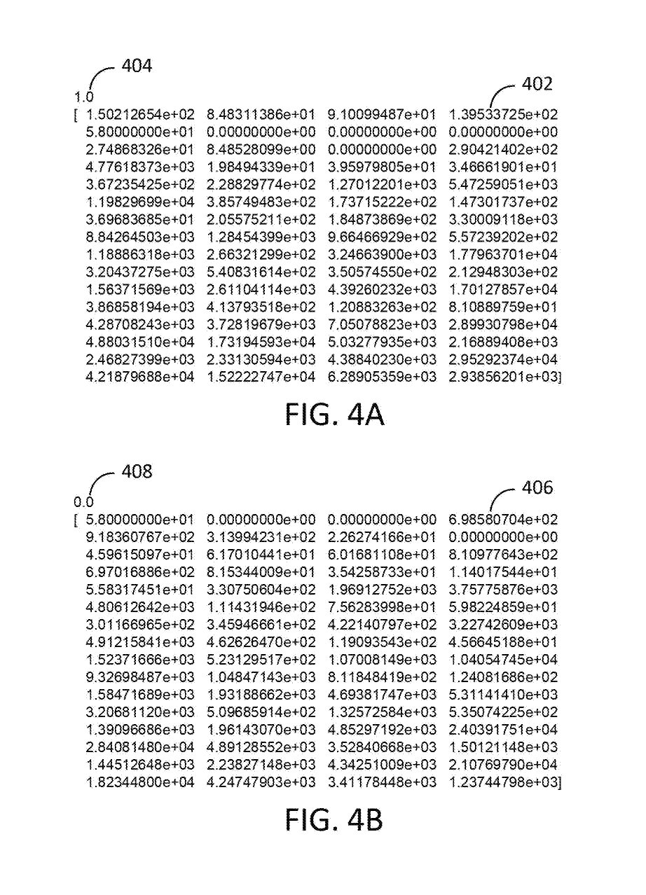

For example, in one or more embodiments, each generic parking spot training images is converted into a histogram of oriented gradients (HOG), in which each HOG is associated with a known occupancy status. FIG. 4A illustrates an example HOG of a generic parking spot training image that is associated with an occupied status. Specifically, the HOG is represented as a matrix 402 of gradient values. The HOG of FIG. 4A, has an occupancy value 404 of 1.0, which designates the HOG as that of an occupied parking spot. Similarly, FIG. 4B illustrates an example HOG of a generic parking spot training image that is associated with an unoccupied status, which is represented as a matrix 406 of gradient values. The HOG of FIG. 4B has an occupancy value 408 of 0.0, which designates the HOG as that of an occupied parking spot.

Referring again to FIG. 3, the method then includes inputting the image descriptor values of the generic parking spot training images into a dynamic classification model (step 306). The dynamic classification model is able to generate occupancy classification rules based on the training data (step 308), which includes examples of image descriptor values associated with occupied status and examples of image descriptor values associated with unoccupied status. After receiving the training data, the dynamic classification model may compare a new image descriptor value of an image of a parking spot 110 with unknown occupancy and estimate the occupancy status of the parking spot 110 by comparing the new image descriptor value to the training data to determine if the new image descriptor value is likely associated with occupied status or unoccupied status, or otherwise applying the occupancy classification rules generated through analyzing training data to classify the new image descriptor value.

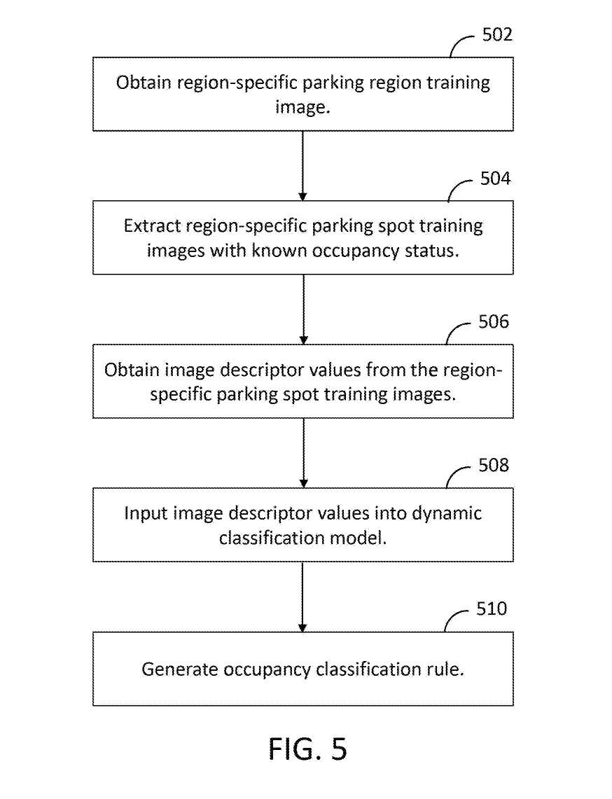

FIG. 5 illustrates a method of training a dynamic classification model using region-specific parking spot training images rather than generic parking spot training images, in accordance with one or more embodiments. The method includes obtaining a region-specific parking region training image, preferably captured using the on-site camera 102 of FIG. 1 (step 502). In one or more embodiments, the method includes extracting a plurality of images of the parking region 108 at different times and showing the parking region 108 in various states of occupancy and under various weather and lighting patterns. Ideally, the images show at least one example of each parking spot 110 of the parking region 108 in an occupied state and at least one example of each parking spot 110 in an unoccupied state.

The method further includes extracting training images of individual parking spots from the training image of the parking region (step 504). In one or more embodiments, the training images of the individual parking spots can be obtained by using an image processing mask technique. The technique includes creating a mask of the training image of the parking region in which the mask defines the individual parking spots 110 within the parking region 108. In one or more embodiments, the mask is a data layer that identifies the regions of the parking region image that are associated with an individual parking spot.

The mask may be created manually or created automatically using an image processing technique. For example, a mask may be created by drawing windows of interest that align with each parking spot and blacking out all areas of the image. Thus, when the mask is applied, the regions of the image that are within the windows are extracted as the individual parking spot images. Alternatively, an image processing technique can be used in which the regions of the parking region image that show individual parking spots are automatically detected and extracted.

Once the mask has been created, the mask can be saved and applied to any subsequent image of the parking region to automatically define the individual parking spot image in the parking region image. In a preferred embodiment, the subsequent images of the parking region are of the same visual field and vantage point. Having determined which portions of the image of the parking region are associated with an individual parking spot, training images of the individual parking spots can be obtained. Each training image of an individual parking spot also has a known occupancy status. In one or more embodiments, the occupancy status is determined and inputted by an operator or obtained according to a historical record, look-up table or the like. Furthermore, in one or more embodiments, the individual parking spot training images are also associated with an address. Specifically, all the individual parking spot training images of the same parking spot 110 are associated with the same address and/or grouped together.

Each of the individual parking spot training images is then converted into a respective image descriptor value (step 506). Each of the image descriptor values is also associated with the respective address and known occupancy status, collectively known as training data. In one or more embodiments, the individual parking spot images may be processed before being converted into a respective image descriptor value. This image processing may be performed to increase or enhance the image in certain ways that will allow a better image descriptor value to be obtained. The image processing may include techniques such as grayscale conversion, Gaussian blur, resizing, cropping, contrast limited adaptive histogram equalization (CLAHE), among others, or in combination.

The method further includes inputting the image descriptor values into the dynamic classification model (step 508). The dynamic classification model is able to generate occupancy classification rules based on the training data (step 510), which includes examples of image descriptor values associated with an occupied status and examples of image descriptor values associated with an unoccupied status. After receiving the training data, the dynamic classification model can compare a new image descriptor value of an image of a parking spot with unknown occupancy and predict the occupancy status of the parking spot by comparing the new image descriptor value to the training data or otherwise applying the occupancy classification rules generated through analyzing training data. In one or more embodiments, the dynamic classification model updates its classification rules as it receives more training data. Thus, the more examples it sees, the more accurate it's classification decisions.

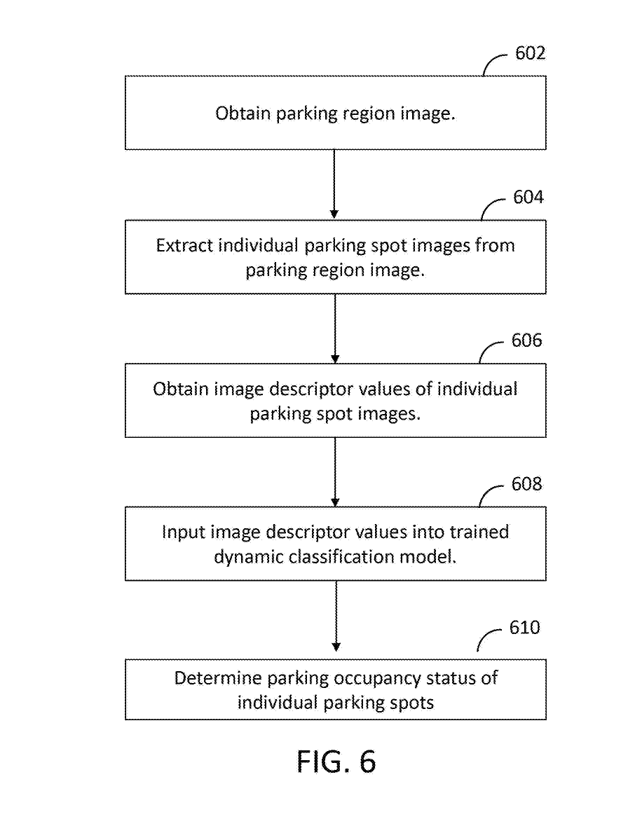

After receiving some training data, whether it be the generic training data of FIG. 3 or the region-specific training data of FIG. 5, the dynamic classification model can be used to determine the occupancy status of a parking spot 110 based on its image descriptor value. FIG. 6 illustrates a method of using a dynamic classification model to determine parking occupancy. The method includes obtaining an image of a parking region 108 via the on-site camera 102 (step 602). The parking region 108 may be a designated parking lot, a street with on-street parking, or any other region of land used for parking vehicles and having one or more parking spots 110. As discussed with reference to FIG. 1, the camera 102 can be a still camera or a video camera. Accordingly, the image may be a still image or a frame taken from a video.

The image of the parking region is captured and sent to a processor 202 (FIG. 2) where it can be manipulated, analyzed, Of otherwise processed. The method further includes extracting images of the individual parking spots within the parking region image (step 604). This can be done by using a Variety of image processing techniques. In an example embodiment, a mask is used to identify the regions of the image region associated with each individual parking spot, which then allows such regions to be extracted, generating the images of the individual parking spots. In embodiments in which the dynamic classification model was trained using region-specific training data (method of FIG. 5), the mask may have been created during the training process and can simply be applied to the image of the parking region. If the mask had not been previously created, then the step of obtaining images of the individual parking spots can also include a step of creating a mask as described above with respect of FIG. 5.

Once the mask is created, it can be applied to any subsequent images of the parking region taken from the camera to automatically extract images of the individual parking spots in the parking region. In one or more embodiments, once the images of the individual parking spots are obtained, the images are processed to emphasize certain features or otherwise prepare the images for use in further steps. Thus, depending on the embodiment, either the original images of the individual parking spots or the processed images of the individual parking spots are then converted into respective image descriptor values (step 606). The method further includes inputting the image descriptor values into a trained dynamic classification model (step 608). The dynamic classification model then uses its classification rules determined during training to classify each of the image descriptor values as being associated with an occupied state or an unoccupied state (step 610). Each image descriptor value is also associated with a spot address so the occupancy state can be assigned to the correct parking spot within the parking region.

The dynamic classification model may utilize one of several dynamic classification or machine learning techniques to classify a parking spot 110 as occupied or unoccupied based on the training data. Specifically, the dynamic classification model may use, but is not limited to using, Logistic Regression, K-nearest neighbor, Support Vector Machine, Random Forest, Neural Networks, among other techniques. For example, in one or more embodiments, an image descriptor value with an unknown occupancy status is compared to the examples of image descriptor values classified as occupied and examples of image descriptor classified as unoccupied to determine to which class the image descriptor value most likely belongs. More specifically, evaluation methods such as Euclidian distance and margin-of-error minimization may be used. These classification methods allow for high accuracy occupancy status classifications despite new and diverse image conditions.

By analyzing the respective image descriptor value of each parking spot image as described above, the classification model is able to determine and output the parking occupancy status for each of the parking spots 110 within a parking region 108. In one or more embodiments, the predicted parking occupancy status can be verified, and if the prediction is verified to be true, the respective image descriptor value and correctly predicted occupancy status can be added to the dynamic classification model as additional training data. Generally, the more training data the dynamic classification model has, the more accurate its occupancy predictions will be. The method of FIG. 6 can be repeated continuously at regular intervals or upon a user command to update the occupancy status of the parking, spots 110 in the parking region 108 over time.

The exemplary embodiment also relates to an apparatus for performing the operations and methods discussed herein. This apparatus may be specially constructed for the required purposes, or it may comprise a general-purpose computer or processor selectively activated or reconfigured by a computer program stored in the computer. Such a computer program may be stored in a computer readable storage medium, such as, but is not limited to, any type of disk including floppy disks, optical disks, CO-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The methods illustrated throughout the specification, may be implemented in a computer program product that may be executed on a computer, processor, or server. The computer program product may comprise a non-transitory computer-readable recording medium on which a control program is recorded, such as a disk, hard drive, or the like. Common forms of non-transitory computer-readable media include, for example, floppy disks, flexible disks, hard disks, magnetic tape, or any other magnetic storage medium, CD-ROM, DVD, or any other optical medium, a RAM, a PROM, an EPROM, a FLASH-EPROM, or other memory chip or cartridge, or any other tangible medium from which a computer can read and use.

It will be appreciated that variants of the above-disclosed and other features and functions, or alternatives thereof, may be combined into many other different systems or applications. Various presently unforeseen or unanticipated alternatives, modifications, variations or improvements therein may be subsequently made by those skilled in the art which are also intended to be encompassed by the following claims.

We claim:

1. A method of detecting parking occupancy status, comprising:
training a dynamic classification model, comprising:
obtaining a plurality of parking spot training images, wherein each of the parking spot training images is associated with a known occupancy status;
obtaining a training image descriptor value from each of the parking spot training images, wherein each training image descriptor value is associated with the respective known occupancy status;
inputting the training image descriptor value and its associated known occupancy status into a dynamic classification model as training data; and
generating a parking spot occupancy classification rule through the dynamic classification model based on the training data.

2. The method of claim 1, wherein the plurality of parking spot training images comprises at least one image a parking spot in an unoccupied state and at least one image of a parking spot in an occupied state.

3. The method of claim 1, wherein the image descriptor value is a histogram of oriented gradients, pixel intensity, pixel red-green-blue values, pixel hue-saturation-value values, a general histogram, or any combination thereof.

4. The method of claim 1, further comprising:
obtaining a parking region training image from an on-site camera, wherein the parking region comprises a plurality of individual parking spots; and
obtaining the plurality of parking spot training images from the parking region training image, wherein the plurality of parking spot training images are images of the individual parking spots of the parking region and are each associated with a parking spot address.

5. The method of claim 4, further comprising:
creating a mask for extracting the plurality of parking spot training images from the parking region training image; and
applying the mask to the parking region training image.

6. The method of claim 1, further comprising:
determining a parking occupancy status of a parking spot within a parking region using a trained dynamic classification model, comprising:
obtaining an actual parking spot image of the parking spot;
obtaining an actual image descriptor value of the actual parking spot image;
applying the parking spot occupancy classification rule to the actual image descriptor value; and
outputting a predicted occupancy status of the parking spot.

7. The method of claim 6, further comprising determining parking occupancy status of a plurality of parking spots within the parking region.

8. The method of claim 6, further comprising pre-processing the actual parking image before obtaining the actual image descriptor using an image processing technique.

9. The method of claim 1, wherein the occupancy classification rule comprises techniques based in Logistic Regression, K-Nearest Neighbor, Support Vector Machine, Random Forest, Neural Networks, or any combination thereof.

10. A method of detecting parking occupancy, comprising:
obtaining an image of a parking region from an on-site camera, wherein the parking region comprises a parking spot;
extracting an image of the parking spot from the image of the parking region;
obtaining an image descriptor value of the image of the parking spot;
inputting the image descriptor value into a dynamic classification model; and
classifying the image descriptor value as occupied or unoccupied based on training data, wherein the training data comprises examples of occupied image descriptor values and unoccupied image descriptor values.

11. The method of claim 10, wherein extracting the image of the parking from the image of the parking region comprises applying a mask to the image of the parking region, wherein the mask defines a portion of the image of the parking region that shows the parking spot.

12. The method of claim 10, wherein classifying the image descriptor value as occupied or unoccupied comprises comparing the image descriptor value to the training data and determining whether the image descriptor value is more similar to the examples of occupied image descriptor values or the example unoccupied image descriptor values.

13. The method of claim 10, wherein classifying the image descriptor value as occupied or unoccupied comprises applying machine learning techniques based in Logistic Regression, K-Nearest Neighbor, Support Vector Machine, Random Forest, Neural Networks, or any combination thereof.

14. The method of claim 10, further comprising:
outputting an occupancy status of the parking spot based on the classification of the image descriptor value and storing the occupancy status in a memory storage device or sending the occupancy status to a receiving party. 15, The method of claim 14, further comprising:
obtaining images of the parking region at regular time intervals or upon command; and
updating the occupancy status of the parking spot.

16. The method of claim 15, further comprising storing a historical record of the occupancy status of the parking spot over a period of time.

17. The method of claim 10, further comprising:
obtaining an image of the parking region from the on-site camera, wherein the parking region comprises a plurality of parking spots;
extracting an image of each parking spot from the image of the parking region;
obtaining an image descriptor value of each parking spot image;
inputting each image descriptor value into the dynamic classification model; and
classifying each image descriptor value as occupied or unoccupied based on the training data.

18. The method of claim 10, wherein the image descriptor value is a histogram of oriented gradients, pixel intensity, pixel red-green-blue values, pixel hue-saturation-value values, a general histogram, or any combination thereof.

19. A parking occupancy detection system, comprising:
a camera; and
one or more processors communicatively coupled to the camera, wherein the one or more processors are collectively configured to:
receive an image of a parking region from the camera, wherein the parking region comprises a parking spot;
extract an image of the parking spot from the image of the parking region;
obtain an image descriptor value of the image of the parking spot;
input the image descriptor value into a dynamic classification model; and
classify the image descriptor value as occupied or unoccupied based on training data, wherein the training data comprises examples of occupied image descriptor values and unoccupied image descriptor values.

20. The system of claim 18, wherein the one or more processors coupled to the camera, remote from the camera, or a combination thereof.
